(19) United States
(12) Patent Application Publication
(10) Pub. No.: US 2025/0061421 A1
(43) Pub. Date: Feb. 20, 2025

(54) INFORMATION PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventors: Shi Qiu, Beijing (CN); Tianjun Xue, Beijing (CN); Wenhai Yang, Beijing (CN); Guilin Cui, Beijing (CN)

(21) Appl. No.: 18/805,510

(22) Filed: Aug. 14, 2024

(30) Foreign Application Priority Data
Aug. 15, 2023 (CN) 202311028529.X

(51) Int. Cl. G06Q 10/10

(52) U.S. Cl. CPC G06Q 10/10

(57) ABSTRACT

The disclosure provides an information processing method, an apparatus, an electronic device and a storage medium. The method includes obtaining at least one piece of first information satisfying a predetermined condition in a target system; inputting a predetermined prompt and the at least one piece of first information into a target model, to obtain second information output by the target model, wherein data volume of the second information is less than that of the first information; and sending the second information to a target service scenario. In this embodiment, the user does not need to read a large amount of first information, the second information concerned in the first information may be directly obtained, time and energy are saved, and efficiency is improved.

### CROSS-REFERENCE

This application claims priority to Chinese Patent Application No. 202311028529.X filed on Aug. 15, 2023, and entitled “INFORMATION PROCESSING METHOD, APPARATUS, ELECTRONIC DEVICE AND STORAGE MEDIUM”, which is incorporated herein by reference in its entirety.

### FIELD

The present disclosure relates to the field of computer technologies, and in particular, to an information processing method, an apparatus, an electronic device, and a storage medium.

### BACKGROUND

During development and maintenance of a product, a user needs to fill up a follow-up record, and a large amount of content is recorded in each follow-up record.

The management user faces a large number of follow-up records, it is difficult to realize all browsing, and the development and maintenance conditions of the product cannot be comprehensively known.

### SUMMARY

In view of the above, the aim of the present disclosure provides an information processing method, an apparatus, an electronic device, and a storage medium.

Based on the above aim, a first aspect of the present disclosure provides a method of information processing, comprising:
obtaining at least one piece of first information satisfying a predetermined condition in a target system;
inputting a predetermined prompt and the at least one piece of first information into a target model, to obtain second information output by the target model, wherein data volume of the second information is less than that of the first information; and
sending the one piece of second information to a target service scenario.

In some embodiments, the method further comprises: before obtaining the at least one piece of first information satisfying the predetermined condition in the target system,
in response to a setting operation of a first type of user, setting the predetermined condition, the predetermined prompt, and the target service scenario.

In some embodiments, setting the predetermined condition comprises at least one of:
setting a trigger time for obtaining the first information;
setting an obtaining period of the first information;
setting a type of the first information, wherein the type of the first information comprises attribute information of a target object.

In some embodiments, the method further comprises: before inputting the at least one piece of first information into the target model, modifying target information in the at least one piece of first information into replacement information:
the method further comprises: after obtaining the second information output by the target model, modifying replacement information in the second information into the target information.

In some embodiments, inputting the predetermined prompt and the at least one piece of first information into the target model to obtain the second information output by the target model comprises: dividing the at least one piece of first information into a plurality of data fragments:
inputting the plurality of data fragments into the target model to obtain sub-information corresponding to each data fragment;
combining the sub-information corresponding to each data fragment to generate the second information corresponding to the at least one piece of first information.

In some embodiments, sending the second information to the target service scenario comprises:
generating an information card based on the second information, and displaying the information card in the target service scenario, to enable a second type of user of the target service scenario to view the information card.

In some embodiments, the target service scenario comprises at least one of a session, a document, a task, a mail, or a conference.

In some embodiments, the information card comprises the one piece of second information and at least one of:
an obtaining time of the second information;
an industry to which the second information belongs;
a product to which the second information belongs;
an obtaining period of the second information.

In some embodiments, the method further comprises:
in response to a trigger operation of the second type of user on any of second information in the information card, displaying the first information associated with the second information that is triggered in the target service scenario.

A second aspect of the present disclosure provides an information processing apparatus, comprising:
an obtaining module, configured to obtain at least one piece of first information satisfying a predetermined condition in a target system;
an input module, configured to input a predetermined prompt and the at least one piece of first information into a target model, to obtain second information output by the target model, wherein data volume of the second information is less than that of the first information; and
a sending module, configured to send the second information to a target service scenario.

A third aspect of the present disclosure provides an electronic device, comprising a memory; a processor, and a computer program stored in the memory and executable on the processor, wherein the processor executes the program to implement the method of information processing according to the first aspect.

A fourth aspect of the present disclosure provides non-transitory computer-readable storage medium storing computer instructions for causing the computer to perform the method of information processing according to the first aspect.

As can be seen from the above, after the first information satisfying the predetermined condition is obtained from the target system, the predetermined prompt and the first information are sent to the target model, the first information is summarized based on the prompt through the target model, so that the second information with the data volume smaller than the first information is output, and the second information is sent to the target service scenario for display; so that the user does not need to read a large amount of first information, the second information concerned by the user in the first information can be directly obtained, the time and energy are saved, and the efficiency is improved.

### BRIEF DESCRIPTION OF DRAWINGS

In order to more clearly illustrate the technical solutions in the present disclosure or related technologies, the accompanying drawings, which need to be used in the description of the embodiments or related technologies, are briefly introduced below, and obviously; the drawings in the following description are merely embodiments of the present disclosure, and for those of ordinary skill in the art, other drawings may be obtained according to these drawings without creative work.

FIG. 1 illustrates a schematic flowchart of an exemplary method according to an embodiment of the present disclosure.

FIG. 2A illustrates a schematic diagram of an exemplary page according to an embodiment of the present disclosure.

FIG. 2B illustrates a schematic diagram of an exemplary page according to an embodiment of the present disclosure.

FIG. 3 illustrates a schematic flowchart of an exemplary method according to an embodiment of the present disclosure.

FIG. 4 illustrates a schematic diagram of an exemplary apparatus according to an embodiment of the present disclosure.

FIG. 5 illustrates a schematic diagram of a hardware structure of an exemplary computer device according to an embodiment of the present disclosure.

### DETAILED DESCRIPTION

In order to make the objectives, technical solutions and advantages of the present disclosure clearer, the present disclosure will be further described in detail below with reference to the accompanying drawings.

It should be noted that, unless otherwise defined, technical terms or scientific terms used in the embodiments of the present disclosure should be of ordinary meanings understood by those skilled in the art to which the present disclosure belongs. The terms “first”. “second” and similar terms used in the embodiments of the present disclosure do not represent any order, quantity, or importance, but are merely used to distinguish different components. A word “comprising” or “comprising” or the like means that an element or object appearing in front of the word encompasses elements or objects appearing behind the word and their equivalents, without excluding other elements or objects. Similar terms such as “connected” or “connected” are not limited to physical or mechanical connections, but may include electrical connections, whether direct or indirect. “Upper”. “lower”. “left”. “right” and the like are only used to represent relative position relationships, and when the absolute position of the object to be described changes, the relative position relationship may also change accordingly.

As described in the background, in the development or maintenance process of a product or some products, a user needs to fill up a follow-up record of the product. Therefore, there will be a large number of follow-up records for the product in the system, and a large amount of content is recorded in each follow-up record.

The management user faces a large number of follow-up records, it is difficult to realize all browsing, and the development and maintenance conditions of the product cannot be comprehensively known. In some cases, some users are required to read a large amount of follow-up records, extract information that needs concern, and write the documents to the management user in a certain format, so that a lot of time is wasted in the whole process, and the efficiency is low.

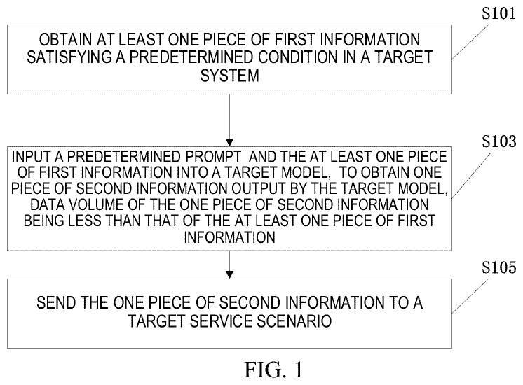

In order to solve the above problem, an embodiment of the present disclosure provides a method of information processing. As shown in FIG. 1, the method of information processing includes:

Step S101: obtain at least one piece of first information satisfying a predetermined condition in a target system.

A large amount of first information exists in the target system, and different first information may be generated for different products, different time periods, and by different user. There may be many pieces of content in each piece of first information, but only part of the content in each piece of first information is concerned about by the target user, and the target user generally does not focus on all pieces of first information in the target system, but focuses on some pieces of first information satisfying their needs. Therefore, the predetermined condition that meets the requirement of the target user may be set, so that when the first information is obtained from the target system based on the predetermined condition, the first information satisfying the user requirement of the target user may be obtained.

Step S103, input a predetermined prompt and the at least one piece of first information into a target model, to obtain second information output by the target model, data volume of the second information being less than that of the first information.

After obtaining the at least one piece of first information meeting the user requirement of the target user, the first information and the predetermined prompt are input into the target model. The prompt is used to prompt the target model for the context of the input information and the parameter information of the input model, which may help the target model better understand the input request, and make a corresponding response, thereby helping the target model to quickly locate the key information.

In this embodiment, a prompt may be predetermined, and information that the target user concerns about is set through the prompt. In this way: based on the predetermined prompt, the second information meeting the prompt requirement in the first information, that is, the information that the target user concerns about may be obtained through the target model.

Since the second information is only the information in the first information that the target user concerns about, the data volume of the second information is less than the data volume of the first information, so that the target user can directly view the second information without looking at a large amount of the first information to obtain the information that the target user concerns about.

In some embodiments, the second information output by the target model may include sub-information corresponding to each piece of first information of the input target model, that is, sub-information that the target user concerns about is extracted from each piece of first information by using the target model, and one piece of second information is generated based on the at least one piece of sub-information corresponding to the at least one piece of first information. Alternatively, the target model extracts one piece of sub-information that the target user concerns about from the plurality of pieces of first information, and generates second information based on the sub-information.

That is, one piece of sub-information in the second information may be generated based on one piece of first information in the input target model, or may be generated based on the plurality of pieces of first information in the input target model, which is not limited in this embodiment.

In an embodiment of the present disclosure, the target model is a model having a summary capability obtained by training based on a predetermined data set, and the specific structure and the training manner of the target model are not limited herein.

In step S105, send the second information to a target service scenario.

After the second information is obtained, the second information is sent to the target service scenario, so that the user of the target service scenario, for example, the target user can view the second information through the target service scenario, so as to obtain the information that the user concerns about in the at least one piece of first information satisfying the predetermined condition in the target system, without need to view a large amount of first information, thereby saving time and improving processing efficiency.

In this embodiment, after the first information satisfying the predetermined condition is obtained from the target system, the predetermined prompt and the first information are sent to the target model, the first information is summarized based on the prompt by using the target model, so that the second information with the data volume less than the first information is output, and the second information is sent to the target service scene for display, so that the user does not need to read a large amount of first information, the second information of the first information that the user concerns about can be directly obtained, the time and energy are saved, and the efficiency is improved.

In some embodiments, the target system may be a system such as a product management system, the product management system is configured to manage development and maintenance of products, and the first information is follow-up information filled in a process of developing and maintaining a product in the product management system. In other embodiments of the present disclosure, the target system may also be other service system, such as project management system, customer relationship management CRM system, etc., which is not limited in this embodiment.

In some embodiments, the method further includes: before obtaining the at least one piece of first information satisfying a predetermined condition in the target system in step S101, in response to a setting operation of a first type of user, setting the predetermined condition, the predetermined prompt, and the target service scenario.

The first type of user may be a management user having a configuration permission, for example, may be an administrator, that is, a management user having a configuration permission may set a predetermined condition, a prompt, and a target service scenario, so that a range of first information obtained from the target system may be determined based on a predetermined condition set, information extraction and summarization are performed on the input first information based on the configured prompt and the target model to obtain second information, and a target object to which the second information is sent is determined based on the set target service scenario.

Alternatively: the first type of user may also be a target user, that is, the target user may set a range of the first information that needs to be obtained from the target system, a requirement of extracting information from the target model, and a target object that the second information is sent, so that their own needs to obtain information may be met, which is not limited in this embodiment.

In some embodiments, setting the predetermined condition includes at least one of: setting a trigger time for obtaining the first information: setting an obtaining period of the first information: setting a type of the first information, wherein the type of the first information comprises attribute information of a target object.

In this embodiment, the trigger time for obtaining the first information may be set. The first information may be obtained regularly: so that the first information meeting the predetermined condition may be obtained from the target system according to the set trigger time, for example, the first information may be obtained X hour every day: every X days, every X weeks, every X months, etc., which is not limited in the embodiment. In some embodiments, the trigger time of obtaining the first information may also be set through the timing task, which is not limited in this embodiment. Here. X represents a number.

In this embodiment, the obtaining period of the first information may also be set, so that the first information satisfying the predetermined condition within the period range may be obtained from the target system according to the set obtaining period, for example, the first information in X hours may be set, the first information in X days may be obtained, the first information in X weeks may be obtained, the first information in the X month may be obtained, which is not limited in this embodiment.

In this embodiment, the type of the first information may also be set, the type of the first information includes the attribute information of the target object, so that the first information corresponding to the attribute information and satisfying the predetermined condition may be requested from the target system according to the set attribute information of the target object.

The attribute information of the target object may include products, industries, and the like. That is, in this embodiment, first information related to one or more products may be obtained, and first information related to products of one or more industries may also be obtained, which is not limited in this embodiment.

In some embodiments, the method further includes: before inputting the at least one piece of first information into the target model in step S103, modifying target information in the at least one piece of first information into replacement information.

The method further includes: after obtaining the one piece of second information output by the target model in step S103, modifying replacement information in the one piece of second information into the target information.

In this embodiment, before the target information in the at least one piece of first information is modified to the replacement information, the replacement information corresponding to the target information may be set based on the setting operation of the first type of user. The target information may be part of information in the first information, for example, a product name, an industry name, or the like.

After the first information is obtained from the target system, the target information in the first information can be replaced with the predetermined replacement information, and then the first information, which is replaced with the replacement information of the target information is input into the target model for information extraction and summarization, so that the second information output by the target model is obtained, the replacement information in the second information is remodified into the target information based on the corresponding relationship between the target information and the replacement information, and then the second information including the target information is sent to the target service scene, so that the safety of the target information in the first information is ensured in the process of extracting and summarizing the first information through the target model.

In some embodiments, inputting the predetermined prompt and the at least one piece of first information into the target model in step S103 to obtain the second information output by the target model includes:

Step S201, divide the at least one piece of first information into a plurality of data fragments.

In this step, one piece of first information may be used as a data fragment, or each piece of first information may be divided into a plurality of data fragments having an equal length of the character string: or, the obtained at least one piece of first information may be spliced according to a predetermined rule, and then divided into a plurality of data fragments whose lengths are equal, which is not limited in this embodiment.

Step S203, input the plurality of data fragments into the target model to obtain sub-information corresponding to each data fragment.

In this embodiment, the N data fragments may be respectively input into the target model, so that the sub-information corresponding to each data fragment is obtained, that is, the N sub-information is obtained, and the N sub-information is in a one-to-one correspondence with the N data fragment.

Step S205: combine the sub-information corresponding to each data fragment to generate the second information corresponding to the at least one piece of first information.

After obtaining the sub-information corresponding to each data fragment, the sub-information is combined to generate the second information.

In some embodiments, after obtaining the at least one piece of first information, the at least one piece of first information may be divided into N pieces of data: then, each piece of data and the prompts are input into the target model, thereby obtaining sub-information corresponding to each piece of data, that is, obtaining N pieces of sub-information; and then, combining the N pieces of sub-information to generate the second information.

Alternatively: after the N pieces of information are obtained, the N pieces of information and another prompt may be input into the target model, to summarize the N pieces of information into one piece of second information, which is not limited in this embodiment. That is, in this embodiment, when there is a requirement, steps S201-S205 may be recursively performed to summarize and reduce the first information to generate second information required by the user.

In the related art, since the data volume of first information is very large, if all the first information is input to the target model at a time, it is difficult to analyze and extract information due to the limitation of calculation capability of the target model. Therefore, in this embodiment, the at least one piece of first information is divided into a plurality of data fragments, and each piece of data fragment and the prompts are respectively input into the target model for information extraction and summarization, and then sub-information corresponding to each piece of first information is combined into second information, so that summary and extraction can be performed based on the model computing power to meet user requirements.

In some embodiments, sending the second information to the target service scenario in step S105 includes: generating an information card based on the second information, and displaying the information card in the target service scenario, to enable a second type of user of the target service scenario to view the information card.

In this embodiment, the information card may be generated based on the second information, and the information card may be displayed in the target service scenario.

In some embodiments, the target service scenario includes at least one of a session, a document, a task, a mail, or a conference.

When the target service scenario is a session, the second type of user may be a member of the session, the information card may be a message card displayed in the chat session and the personal session, and the second information may be pushed to the member of the session through the message in the session.

When the target service scenario is a document, the second-type user may be a collaborator of the document, and the information card may be a document card displayed in the document, that is, the second information may be pushed to the collaborator of the document through the document.

When the target service scenario is a task, the second type of user may be a collaborator of the task, the information card may be a task card displayed in the task, and when the collaborator of the task configures the summary task for the first information in the task, the second information may be pushed to the collaborator of the task through the task.

When the target service scenario is a mail, the second type of user may be a receiver of the mail, and the information card may be a mail information card displayed in the mail, that is, the second information may be pushed to the user through the mail.

When the target service scenario is a conference, the second type of user may be a participant of the conference, the information card may be a conference card displayed in the conference, and when the user is in the conference, the second information may be pushed to the participant of the conference through the conference.

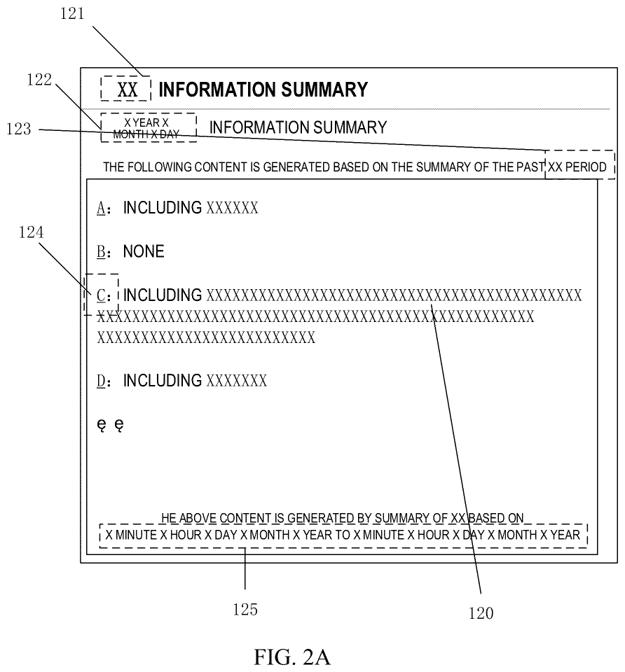

In some embodiments, as shown in FIG. 2A, the information card includes the second information 120, so that the second type of user in the target service scenario may view the second information 120 when receiving the information card.

In some embodiments, the information card may further include at least one of: the information card includes the second information 120 and at least one of: an obtaining time of the second information: an industry to which the second information belongs: a product to which the second information belongs: an obtaining period of the second information. The obtaining time of the second information is displayed in the information card, so that the user can know that the second information obtained by the user is obtained based on the first information before the obtaining time, so that the user knows when the second information is obtained by the user: the industry to which the second information belongs is displayed in the information card, so that the user can know the second information is generated based on which industry of the first information: the product to which the second information belongs is displayed in the information card, so that the user can know the second information is generated based on which product of the first information; and the obtaining period of the second information is displayed in the information card, so that the user can know the second information is generated based on which period of generating the first information. In this way, when viewing the information card, the second type of user can know the acquisition time, the acquisition period, the industry to which the second information belongs or the product to which the second information belongs, so that the relevant information of the second information can be clearly known.

As shown in FIG. 2A, the first area 121 in the information card may be used to display the industry or the product to which the second information 120 belongs, and when the first area 121 displays the industry name, it indicates that the second information 12 in the information card is generated based on the first information in the industry. When the first area 121 displays the product name, it indicates that the second information 12 in the information card is generated based on the first information of the product. The second area 122 in the information card may be used to display the obtaining time of the second information 120, representing the generation time of the second information 120. The third region 123 in the information card may be used to display an obtaining period of the second information 120, representing a generation period for generating the second information 120. The fourth area 125 in the information card may be used to display the combination of the obtaining time and the obtaining period of the second information 120, representing the time of the first information corresponding to the second information 120.

In some embodiments, one or more pieces of second information may be displayed in the information card, and each piece of second information is associated with one or more pieces of first information, that is, one piece of second information is generated based on the one or more pieces of first information extracted by the target model.

The method further includes: in response to a trigger operation of the second type of user on the second information in the information card, displaying the first information associated with the second information that is triggered in the target service scenario.

In this embodiment, when the second type of user triggers an operation on the second information in the information card, the first information associated with the triggered second information may be displayed in the target service scenario, that is, after the second type of user views the extracted and summarized second information, if it is desired to view the original first information, the second type of user may also check. In some embodiments, as shown in FIG. 2A, the name 124 of the product may be set as a link, when the user of the second type wants to trigger the second information, the name 124 of the product may be directly clicked, the page 110 displaying the first information may be jumped to the target system based on the link of the product name, as shown in FIG. 2B, and the first information corresponding to the triggered second information is displayed in the page 110, so as to facilitate viewing of the user of the second type.

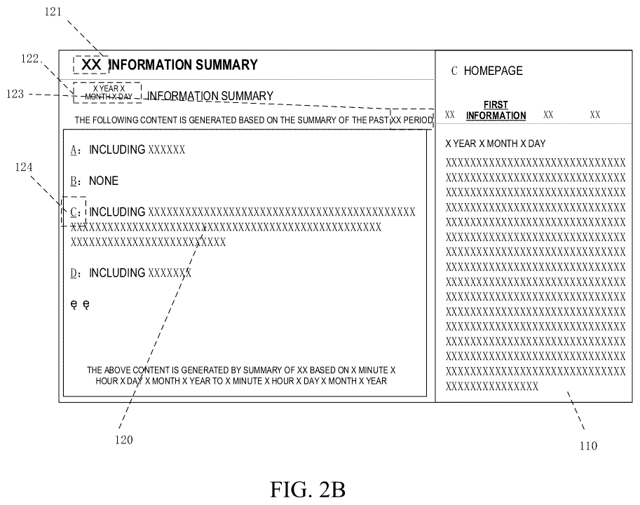

As shown in FIG. 3, the present disclosure further provides an information processing method, including:

Step S301, the first type of user sets a predetermined operation on the summary platform, sets a predetermined condition, a prompt and a target service scenario.

Optionally: the first type of user may further set replacement information corresponding to the target information in the first information.

The summary platform may be implemented by using a service, which is not limited in this embodiment.

Step S302: the summary platform sends a request for obtaining an information to the target system, where the request for obtaining an information includes a predetermined condition, so as to request for obtain the first information satisfying the predetermined condition from the target system.

The predetermined condition includes at least one of: a trigger time for obtaining the first information, an obtaining period of the first information, and a type of the first information. The type of the first information comprises attribute information of a target object, and the attribute information of the target object may include industry, product, etc., which is not limited in this embodiment.

Step S303: The summary platform receives at least one piece of first information sent by the target system, where the at least one piece of first information satisfies a predetermined condition.

Step S304: The summary platform modifies the target information in the at least one piece of first information into replacement information based on a predetermined correspondence between the target information and the replacement information.

Step S305: The summary platform sends the prompt and the at least one piece of first information to the target model. The at least one piece of first information is information obtained after the target information is modified into replacement information.

Step S306: The target model processes the at least one piece of first information based on the prompt to obtain second information. In the second information, there is only replacement information and there is no target information.

Step S307: The target model sends the second information to the summary platform.

Step S308, the summary platform modifies the replacement information in the second information into the target information based on a predetermined correspondence between the target information and the replacement information.

Step S309: The summary platform generates an information card based on the second information, and sends the information card to the open platform.

Step S310: The open platform pushes the information card to the target service scenario.

The open platform is configured to provide an interface of the system, to display content and style of the information card based on the system interface, and push the information card into the target service scenario.

After receiving the information card, the target service scenario may further send return information to the open platform and the summary platform in sequence, to notify the summary platform that the information card has been received.

In some embodiments, the target system may further be a sales management system, and the first information may be sales follow-up information, which is not limited in this embodiment.

It may be understood that, before the technical solutions of the embodiments of the present disclosure are used, the user may be notified of the type of the involved personal information, the usage scope, the usage scenario and the like in an appropriate manner, and the authorization of the user is obtained.

For example, in response to receiving an active request from a user, prompt information is sent to the user to explicitly prompt the user, and the operation need to obtain and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It should be noted that the method in the embodiments of the present disclosure may be performed by a single device, for example, a computer or a server. The method in this embodiment may also be applied to a distributed scenario, and the plurality of devices cooperate to complete. In this distributed scenario, one of the plurality of devices may perform only one or more steps in the method in the embodiments of the present disclosure, and the plurality of devices interact with each other to complete the method.

It should be noted that some embodiments of the present disclosure are described above. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain embodiments, multitasking and parallel processing are also possible or may be advantageous.

Based on the same inventive concept, corresponding to any of the above embodiments, the present disclosure further provides an information processing apparatus.

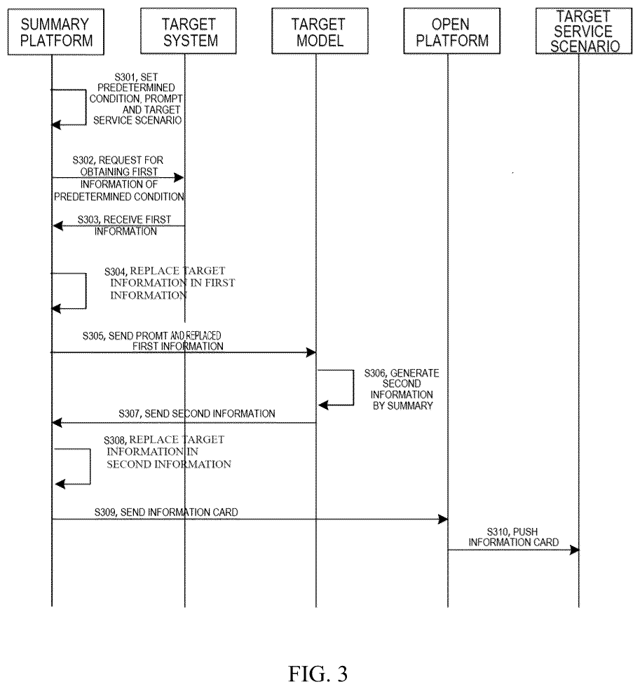

Referring to FIG. 4, the apparatus includes:
an obtaining module 11, configured to obtain at least one piece of first information satisfying a predetermined condition in a target system.
an input module 13, configured to input a predetermined prompt and the at least one piece of first information into a target model, to obtain second information output by the target model, wherein data volume of the second information is less than that of the first information.
a sending module 15, configured to configured to the second information to a target service scenario.

In some embodiments, the apparatus is further configured to: before obtaining the at least one piece of first information meeting the predetermined condition in the target system,
in response to a setting operation of a first type of user, set the predetermined condition, the predetermined prompt, and the target service scenario.

In some embodiments, setting the predetermined condition includes at least one of:
setting a trigger time for obtaining the of first information;
setting an obtaining period of the first information;
setting a type of the first information, wherein the type of the first information comprises attribute information of a target object.

In some embodiments, the apparatus is further configured to: before inputting the at least one piece of first information into the target model, replacement information in the one piece of second information into the target information.

The apparatus is further configured to: after obtaining the second information output by the target model, modify the replacement information in the second information to the target information.

In some embodiments, the input module 13 is further configured to:
divide the at least one piece of first information into a plurality of data fragments;
input the plurality of data fragments into the target model to obtain sub-information corresponding to each data fragment;
combine the sub-information corresponding to each data fragment to generate the second information corresponding to the at least one piece of first information.

In some embodiments, the sending module 15 is further configured to:
generate an information card based on the second information, and displaying the information card in the target service scenario, to enable a second type of user of the target service scenario to view the information card.

In some embodiments, the target service scenario comprises at least one of a session, a document, a task, a mail, or a conference.

In some embodiments, the information card comprises the one piece of second information and
at least one of;
an obtaining time of the second information;
an industry to which the second information belongs;
a product to which the second information belongs;
an obtaining period of the second information.

In some embodiments, the apparatus is further configured to:
in response to a trigger operation of the second type of user on the second information in the information card, display the first information associated with the second information that is triggered in the target service scenario.

For convenience of description, the above apparatus is described when the above apparatus is described. Of course, the functions of the modules may be implemented in one or more software and/or hardware when implementing the present disclosure.

The apparatus of the foregoing embodiment is configured to implement the corresponding method of information processing in any one of the foregoing embodiments, and has the beneficial effects of the corresponding method embodiments, and details are not described herein again.

Based on the same inventive concept, the present disclosure further provides an electronic device, including a memory, a processor, and a computer program stored in the memory and executable on the processor, where when the processor executes the program, the information processing method according to any one of the above embodiments is implemented.

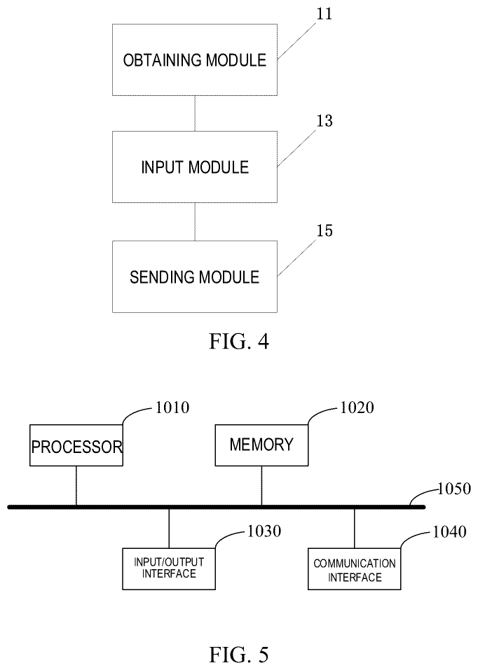

FIG. 5 is a schematic structural diagram of a more specific hardware structure of an electronic device according to this embodiment, and the device may include a processor 1010, a memory 1020, an input/output interface 1030, a communications interface 1040, and a bus 1050. The processor 1010, the memory 1020, the input/output interface 1030, and the communications interface 1040 implement, by using the bus 1050, a communication connection with each other inside the device.

The processor 1010 may be implemented by using a general-purpose central processing unit (CPU), a microprocessor, an application specific integrated circuit (ASIC), or one or more integrated circuits, and is configured to execute related programs to implement the technical solutions provided in the embodiments of the present specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the present specification by using software or firmware, related program code is stored in the memory 1020 and invoked and executed by the processor 1010.

The input/output interface 1030 is configured to connect the input/output module to implement information input and output. The input/output module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communications interface 1040 is configured to connect a communications module (not shown in the figure), to implement communications interaction between the device and another device. The communications module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device, such as the processor 1010, the memory 1020, the input/output interface 1030, and the communication interface 1040.

It should be noted that although the foregoing device only shows the processor 1010, the memory 1020, the input/output interface 1030, the communications interface 1040, and the bus 1050, in a specific implementation process, the device may further include other components necessary to implement normal running. In addition, those skilled in the art may understand that the foregoing device may also include only components necessary for implementing the solutions in the embodiments of the present specification, and does not necessarily include all components shown in the figure.

The electronic device of the foregoing embodiment is configured to implement the corresponding information processing method in any one of the foregoing embodiments, and has the beneficial effects of the corresponding method embodiments, and details are not described herein again.

Based on the same inventive concept, the present disclosure further provides a non-transitory computer-readable storage medium storing computer instructions for causing the computer to perform the information processing method according to any one of the above embodiments.

Computer-readable media of the present embodiments include permanent and non-permanent, removable and non-removable media that can be stored by any method or technology. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically crasable programmable read only memory (EEPROM), flash memory or other memory technology; compact disc read-only memory (CD-ROM), digital versatile disc (DVD) or other optical storage, magnetic cassettes, magnetic tape magnetic disk storage or other magnetic storage devices, or any other non-transmission medium, which can be used to store information that can be accessed by a computing device.

The computer instructions stored in the storage medium in the foregoing embodiments are configured to cause the computer to perform the information processing method according to any one of the foregoing embodiments, and have the beneficial effects of the corresponding method embodiments, and details are not described herein again.

It should be understood by those of ordinary skill in the art that the discussion of any of the above embodiments is merely exemplary and is not intended to suggest that the scope of the present disclosure, including the claims, is limited to these examples: in the spirit of the present disclosure, the above embodiments or the technical features in different embodiments may also be combined, the steps may be implemented in any order, and there are many other variations of the different aspects of the embodiments of the present disclosure as described above, which are not provided in detail for the sake of brevity.

Additionally, for simplicity of illustration and discussion, and to not obscure embodiments of the present disclosure, well-known power/ground connections to integrated circuit (IC) chips and other components may or may not be shown in the figures provided. Moreover, the apparatus may be shown in block diagram form in order to avoid obscuring the embodiments of the present disclosure, and this also takes into account the fact that the details regarding the implementation of these block diagram devices are highly dependent on the platform in which the embodiments of the present disclosure are to be implemented (i.e., these details should be fully within the understanding of those skilled in the art). Having set forth specific details (e.g., circuits) to describe exemplary embodiments of the present disclosure, it will be apparent to those skilled in the art that embodiments of the present disclosure may be practiced without these specific details or with changes to these specific details. Accordingly, these descriptions should be considered illustrative and not limiting.

Although the present disclosure has been described in conjunction with specific embodiments of the present disclosure, many alternatives, modifications, and variations of these embodiments will be apparent to those of ordinary skill in the art from the foregoing description. For example, other memory architectures (e.g., dynamic RAM (DRAM)) may use the embodiments discussed.

The present disclosure is intended to cover all such alternatives, modifications and variations that fall within the broad scope of the appended claims. Therefore, any omission, modification, equivalent replacement, improvement and the like that are made within the spirit and principle of the embodiments of the present disclosure should be included within the protection scope of the present disclosure.

I/We claim:

1. A method of information processing, comprising:
obtaining at least one piece of first information satisfying a predetermined condition in a target system;
inputting a predetermined prompt and the at least one piece of first information into a target model, to obtain second information output by the target model, wherein data volume of the second information is less than that of the first information; and
sending the second information to a target service scenario.

2. The method of claim 1, wherein the method further comprises: before obtaining the at least one piece of first information satisfying the predetermined condition in the target system,
in response to a setting operation of a first type of user, setting the predetermined condition, the predetermined prompt, and the target service scenario.

3. The method of claim 2, wherein setting the predetermined condition comprises at least one of:
setting a trigger time for obtaining the first information;
setting an obtaining period of the first information;
setting a type of the first information, wherein the type of the first information comprises attribute information of a target object.

4. The method of claim 1, wherein the method further comprises: before inputting the at least one piece of first information into the target model, modifying target information in the at least one piece of first information into replacement information:
the method further comprises: after obtaining the second information output by the target model, modifying replacement information in the second information into the target information.

5. The method of claim 1, wherein inputting the predetermined prompt and the at least one piece of first information into the target model to obtain the second information output by the target model comprises:
dividing the at least one piece of first information into a plurality of data fragments;
inputting the plurality of data fragments into the target model to obtain sub-information corresponding to each data fragment;
combining the sub-information corresponding to each data fragment to generate the second information corresponding to the at least one piece of first information.

6. The method of claim 1, wherein sending the second information to the target service scenario comprises:
generating an information card based on the second information, and displaying the information card in the target service scenario, to enable a second type of user of the target service scenario to view the information card.

7. The method of claim 1, wherein the target service scenario comprises at least one of a session, a document, a task, a mail, or a conference.

8. The method of claim 6, wherein the information card comprises the second information and at least one of:
an obtaining time of the second information;
an industry to which the second information belongs;
a product to which the second information belongs;
an obtaining period of the second information.

9. The method of claim 6, further comprising:
in response to a trigger operation of the second type of user on any of second information in the information card, displaying the first information associated with the second information that is triggered in the target service scenario.

10. An electronic device, comprising a memory, a processor, and a computer program stored in the memory and executable on the processor, wherein the processor executes the program to implement acts comprising:
obtaining at least one piece of first information satisfying a predetermined condition in a target system;
inputting a predetermined prompt and the at least one piece of first information into a target model, to obtain second information output by the target model, wherein data volume of the second information is less than that of the first information; and
sending the second information to a target service scenario.

11. The electronic device of claim 10, wherein the acts further comprise: before obtaining the at least one piece of first information satisfying the predetermined condition in the target system,
in response to a setting operation of a first type of user, setting the predetermined condition, the predetermined prompt, and the target service scenario.

12. The electronic device of claim 11, wherein setting the predetermined condition comprises at least one of:
setting a trigger time for obtaining the first information;
setting an obtaining period of the first information;
setting a type of the first information, wherein the type of the first information comprises attribute information of a target object.

13. The electronic device of claim 10, wherein the acts further comprise: before inputting the at least one piece of first information into the target model, modifying target information in the at least one piece of first information into replacement information:
the acts further comprise: after obtaining the second information output by the target model, modifying replacement information in the second information into the target information.

14. The electronic device of claim 10, wherein inputting the predetermined prompt and the at least one piece of first information into the target model to obtain the second information output by the target model comprises:
dividing the at least one piece of first information into a plurality of data fragments;
inputting the plurality of data fragments into the target model to obtain sub-information corresponding to each data fragment;
combining the sub-information corresponding to each data fragment to generate the second information corresponding to the at least one piece of first information.

15. The electronic device of claim 10, wherein sending the second information to the target service scenario comprises:
generating an information card based on the second information, and displaying the information card in the target service scenario, to enable a second type of user of the target service scenario to view the information card.

16. The electronic device of claim 10, wherein the target service scenario comprises at least one of a session, a document, a task, a mail, or a conference.

17. The electronic device of claim 15, wherein the information card comprises the second information and at least one of:
an obtaining time of the second information;
an industry to which the second information belongs;
a product to which the second information belongs;
an obtaining period of the second information.

18. The electronic device of claim 15, the acts further comprise:
in response to a trigger operation of the second type of user on any of second information in the information card, displaying the first information associated with the second information that is triggered in the target service scenario.

19. A non-transitory computer-readable storage medium storing computer instructions for causing the computer to implement acts comprising:
obtaining at least one piece of first information satisfying a predetermined condition in a target system;
inputting a predetermined prompt and the at least one piece of first information into a target model, to obtain second information output by the target model, wherein data volume of the second information is less than that of the first information; and
sending the second information to a target service scenario.

20. The non-transitory computer-readable storage medium of claim 19, wherein the acts further comprise: before obtaining the at least one piece of first information satisfying the predetermined condition in the target system,
in response to a setting operation of a first type of user, setting the predetermined condition, the predetermined prompt, and the target service scenario.
